(19) United States
(12) Patent Application Publication
(10) Pub. No.: US 2009/0181209 A1
(43) Pub. Date: Jul. 16, 2009

(54) REINFORCED COMPOSITE CONTAINER FLOORING WITH RESIN-IMPREGNATED VENEERS AND METHOD OF MANUFACTURE

(75) Inventors: Qisheng ZHENG, Edmonton (CA); Robert WELLWOOD, Edmonton (CA); Xu BIN, Edmonton (CA); Liheng CHENG, Edmonton (CA); Shenxue JIANG, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: ALBERTA RESEARCH COUNCIL INC., Edmonton (CA)

(21) Appl. No.: 12/353,809

(22) Filed: Jan. 14, 2009

(30) Foreign Application Priority Data
Jan. 14, 2008 (CN) 200810019106.0

(51) Int. Cl. B32B 21/14; B32B 21/06; B32B 3/10; B32B 37/10; B32B 38/08; B32B 37/16

(52) U.S. Cl. 428/106; 428/537.1; 156/228

(57) ABSTRACT

The invention includes reinforced composite container flooring with resin-impregnated veneers, a core layer which may be formed from a structural stone-based panel or a multi-layer wood veneer panel, and its manufacturing processes.

### FIELD OF THE INVENTION

The invention relates to wood-based composite panels in the forest products industry and their use as container flooring material.

### BACKGROUND OF THE INVENTION

Container flooring is the main load-bearing component in a shipping container, which requires high mechanical properties and good appearance, nail-holding capacity, impact resistance, and ageing resistance. Conventional container flooring uses multiple-layered thick plywood made of Keruing and Apitong, which are hardwood species growing in tropical rainforests. Due to the long growth cycles of these species and over-logging, Keruing and Apitong logs with large diameters are in short supply.

The performance requirements of container flooring materials are based on the historical performance of Apitong, Keruing and similar traditional species of hardwoods to pass the common practice loading of ISO 1496-1 plus ⅓ in the container industries. In general, a suitable container floorboard must achieve a minimum of 12 to 15 years of service life and must focus on ensuring floor panel bond strength, new panel planar shear strength and long-term adhesive bond durability as expected and experienced in its normal operational environment. In part, the ability to withstand repeated high horizontal shear loads mandates a minimum thickness of about 28 mm, with a density of about 0.70 g/cm³-0.88 g/cm³. The wood species used must match or exceed the performance of traditional Apitong/Keruing panels. Generally, suppliers are required to provide evidence of satisfactory performance for all plywood panels.

Suitable container floorboards should demonstrate performance characteristics such as short span test required by IICL (Institute of International Container Lessor) and the ISO 1496-1 floorboard strength test. The short span test is a three point bending test for simulating the actual loading conditions of the panels inside the container with a test failure of 1552 lbf (pound-force). The ISO 1496-1 plus ⅓ floorboard strength test uses a forklift vehicle and requires a test vehicle loaded with an axle load of 3630 kg per wheel (2 wheel load of 7260 kg) to manoeuvre slowly over the board for at least 5 full pass cycles with deformation less than 3 mm at several specific points. Failure for both tests includes delaminating ply separation or cracks in the veneers due to rolling shear or panel breakage due to low bending stiffness and strength.

There is a need in the art for container flooring panels which use alternative materials, allowing preservation of tropical hardwood species traditionally used for this purpose.

### SUMMARY OF THE INVENTION

The present invention has practical value to the protection of tropical hardwood species by developing new types of floorboards for containers, and widening the source of materials for container floorboards.

In one aspect, the invention may comprise a container flooring comprising a core layer and symmetrical surface layers on both surfaces of the core panel each comprising a resin-impregnated wood veneer layer. The resin-impregnated wood veneer layer may comprise poplar, pine, eucalyptus, spruce or fir wood. The surface layers may each comprise, in sequence from inside toward outside, at least one layer of perpendicular-grained phenol-formaldehyde resin-impregnated wooden veneer, and at least 2 layers of parallel-grained resin-impregnated wooden veneers. The resin-impregnated wooden veneers may have been dried under low temperature. The core layer may comprises a structural strand-based panel or a multi-layer wood veneer panel, which may comprise multiple layers of parallel-grained and perpendicular-grained veneers assembled in accordance with layout requirements of container flooring to form the core layer. Each surface layer may further comprise an outer hardwood veneer layer, such as an Apitong or Keruing veneer. Each surface layer may further comprise an outer layer of resin-impregnated paper as the outermost surface layer. Each surface layer may further comprise a layer of resin-impregnated bamboo curtain sheet or woven-mat sheet.

In another aspect, the invention may comprise a method of manufacturing a container flooring comprising a core layer and surface layers on both surfaces of the core panel each comprising a resin-impregnated wood veneer layer, comprising the step of impregnating the wood veneer with a resin, symmetrically assemble the surface layers with the core layer to form a mat; consolidate the assembled mat by hot-pressing; gradually reducing the press pressure in steps for degassing and relieving the press pressure. In one embodiment, the method further comprises the step of impregnating a paper or bamboo layer with a resin, and using it in a surface layer. The resin impregnation step may comprise the steps of drying the wood veneer to a moisture content of less than about 12%, spread resin on both sides with the spread rate of 250 to 350 g/m² (resin solid content is 40% to 50%); impregnate the wood veneer with resin with the resin retention rate of 15% to 50% and then are conditioned or dried under low temperature. The resin impregnation step may comprise the steps of: drying the bamboo layer to a moisture content of less than about 12%, diluting the resin to a solid content of 30% to 36%, impregnating the bamboo with resin under the normal pressure with the resin retention of 7% to 10%.

The resin impregnation step may comprises a direct pressurized treatment; a vacuum and pressurized treatment; a pressurized, vacuum and pressurised treatment; or a combination of repeat vacuum and pressurized treatments to induce the resin to penetrate into cell lumens and cell walls of the veneers.

In one embodiment, the hot-pressing conditions comprise a press temperature from 125 to 150° C. and press pressure from 2.0 to 4.0 MPa for 5 to 10 minutes. The core layer may comprises a strand layer which is pre-pressed prior to mat consolidation.

The invention utilizes resin impregnated materials. Resin is penetrated into the cell lumens, cell walls and cracks of veneers with impregnation treatments and assemble these resin-impregnated veneers, and optionally with other untreated veneers, on a structural strand-based panel as the core layer to form a mat. Using a hot pressing technique to consolidate the mat, this manufactures the reinforced composite container flooring. This invention comprises a structural strand-based panel or multiple-layers of wood veneers as the core layer, and resin-impregnated wood veneers (or impregnated bamboo curtain sheets, bamboo woven-mat sheets), resin-impregnated paper, or hardwood veneers of Keruing or Apitong as the components to assemble separately or together into the surface layers.

After hot pressure consolidation, the integration between resin and wood tissues increases the mechanical properties and improves the dimensional stability of the veneer. In one embodiment, impregnation treatment involves immersing the veneers in resin inside a pressure vessel and then conducting vaccum or pressure-manipulation treatments. The choice of treatment may be made based on wood properties and the required resin retention. The same impregnation treatments are also applicable to bamboo curtain sheets and bamboo woven-mat sheets as well.

According to mechanical theory of composite materials, contribution of each layer of a multi-layer composite panel to the entire panel's strength (MOR) and modulus of elasticity (MOE) is proportional to the strength and modulus of elasticity of each individual layer and the square of its distance to the central layer. Thus, the farther the monolayer material with large strength and modulus of elasticity is from the central layer, the greater the mechanical properties it will contribute. Therefore, the strength and modulus of elasticity of the container flooring will be greatly increased by impregnating common veneers with resin and then symmetrically overlaying them onto both surfaces of the mat substance before or after the hot-pressing consolidation.

With this invention, it is possible to efficiently utilize different wood species of various diameters to manufacture container floorboards and meet international container standards. The consolidation by hot pressing of resin-impregnated wood veneers, resin-impregnated paper, or other materials as surface layers, and a core layer comprising a structural strand-based panel or a pressed multi-layer wood veneer (plywood) panel assembled in accordance with requirements of the layout of container flooring, produces a container floorboard which has suitable properties, such as strength, modulus of elasticity, and other performance indices, and in some instances superior to existing container floorboards. For example, the strength and modulus of elasticity of composite container floorboards meet requirements of container flooring, and its weather resistance and abrasive resistance are superior to existing container floorboards by using the structural strand-based panel as the core layer, and applying, from outside toward inside, 2 to 3 layers of parallel-grained resin-impregnated veneers and 1 layer of perpendicular-grained resin-impregnated as the surface layers onto upper and lower surface of the core layer; or by applying in turns, from outside toward inside, with Keruing veneer, 1 to 2 layers of parallel-grained and 1 layer of perpendicular-grained resin-impregnated veneers to from the surface layer; or using in turns, from outside to inside, resin-impregnated paper, 1 to 2 layers of resin-impregnated veneers, 1 layer of resin-impregnated bamboo curtain sheet, and one layer of perpendicular-grained resin-impregnated veneer as raw materials of the surface layer and then combine them with the core layer to assemble the mat; or by applying 11 to 13 layers of parallel-grained and perpendicular-grained veneers as the core layer and 3 layers of parallel-grained resin-impregnated veneer and one layer perpendicular-grained veneer as the surface layer onto upper and lower surface of the core layer, and have them assembled into the mat and pressed to produce container floorboards.

### BRIEF DESCRIPTION OF THE DRAWINGS

FIG. 1 shows one embodiment of the invention in cross-section. The floorboard has a structural strand-based panel as the core layer and resin-impregnated veneers as surface layers. Item (1) is a parallel-grained phenol-formaldehyde resin-impregnated wood veneer that have been dried under low temperature; Item (2) is a perpendicular-grained phenol-formaldehyde resin-impregnated wood veneer that have been dried under low temperature; Item (3) is a strand-based core panel.

FIG. 2 shows another embodiment of the invention in cross-section. The floorboard uses 11 to 13 layers of parallel-grained and perpendicular-grained veneer as the core layer and resin-impregnated veneers as the surface layers. Item (1) is a parallel-grained phenol-formaldehyde resin-impregnated wood veneer that have been dried under low temperature; Item (2) is a perpendicular-grained phenol-formaldehyde resin-impregnated wood veneer that have been dried under low temperature; Item (4) is a multiple-layer veneer core structure assembled in accordance with layout requirements of container flooring.

FIG. 3 shows another embodiment of the invention in cross section. The floorboard has a structural strand-based panel as the core layer and Keruing or Apitong veneers and resin-impregnated veneers as the surface layers. Item (5) is a Keruing or Apitong wood veneer (or other wood veneer of similar properties); Item (1) is a parallel-grained phenol-formaldehyde resin-impregnated wood veneer that have been dried under low temperature; Item (2) is a perpendicular-grained phenol-formaldehyde resin-impregnated wood veneer that have been dried under low temperature; Item (3) is a strand-based core panel.

FIG. 4 shows another embodiment of the invention in cross section. The floorboard has a structural strand-based panel as the core layer and the phenol-formaldehyde resin-impregnated paper, resin-impregnated veneer, and resin-impregnated bamboo curtain sheet (or bamboo woven-mat sheet) as the surface layers. Item (7) is a phenol-formaldehyde resin-impregnated paper; Item (1) is a parallel-grained phenol-formaldehyde resin-impregnated wood veneer that have been dried under low temperature; Item (6) is a resin-impregnated bamboo curtain sheet (or bamboo woven-mat sheet); Item (2) is a perpendicular-grained phenol-formaldehyde resin-impregnated wood veneer that have been dried under low temperature; Item (3) is a strand-based core panel.

### DETAILED DESCRIPTION OF PREFERRED EMBODIMENTS

When describing the present invention, all terms not defined herein have their common art-recognized meanings. As used herein, the term “about” refers to a margin of plus or minus 10%, or within the tolerance of a suitable measuring device or instrument. All values of wood density refers to the density of oven-dried wood.

The term “resin” means a natural or synthetic resin which has adhesive and water-repellant properties. The resin may be weather resistant, and may include, without limitation, formaldehyde resins such as phenol-formaldehyde or melamine-formaldehyde but may include any other weather resistant resin of similar properties.

The present invention relates to a resin impregnated-wood composite board suitable for use as a container flooring material. In general terms, the invention comprises a multilayer board having a surface composite resin impregnated wooden veneer layer and a wooden core layer. In one embodiment, the resin is a weather resistant resin. As used herein, the term “impregnated” shall mean the resin has penetrated cell walls or cell lumens of the treated material, under a vacuum or pressure treatment.

In one embodiment, the wood veneer layers comprises a wood veneer in either perpendicular-grained or parallel-grained orientation or multiple veneers in alternating perpendicular and parallel layers. As used herein, “parallel-grained” refers to wood grain which is parallel to the longitudinal axis of the board. “Perpendicular-grained” refers to wood grain which is perpendicular the longitudinal axis of the board. The wood veneer layers may be comprised of Keruing or Apitong, or other wood species such as pine (Larch, Chinese red pine, Simao pien, and etc.), fir, poplar, spruce or eucalyptus.

If used, a bamboo layer may comprise bamboo strip sheets made of strips of bamboo and a suitable resin. The bamboo strips may be arranged so that the bamboo strips are all parallel, or parallel and perpendicular combination, or they ma y be layered or woven in a crisscrossing pattern. The bamboo layer may comprise bamboo curtains made from strips of bamboo held together with string. The bamboo layer may also comprise a strip sheet bamboo-woven mat made of strips of bamboo in a crisscrossing pattern and a suitable resin.

The wood core layer may comprise wood veneers in either perpendicular-grained or parallel-grained orientation or in alternating perpendicular and parallel layers. As well, or alternatively, the wood core layer may comprise of multiple layers of wood strand, which comprises wood strand chips similar to those suitable for use in oriented strand boards. The wooden-strands layer may be oriented or non-oriented.

The wood core layer may preferably be comprised of any suitable density wood. Suitable wood species may include poplar, pine and eucalyptus, spruce or fir or others with similar properties. Preferably, the wood species is a fast growing species which may provide a plentiful and low-cost supply. The wood core layer may be comprised of a single tree species or a mixture of various tree species with similar properties.

In one embodiment, the invention comprises a reinforced composite container flooring with resin-impregnated veneers, characterized by using the structural strand-based panel or multiple-layers of wood veneers as the core layer, and symmetrically overlaying 2 to 4 layers of phenol-formaldehyde resin-impregnated wood veneers onto upper and lower surfaces of the core layer; or overlaying, from outside toward inside, a piece of resin-impregnated paper and 2 to 4 layers of phenol-formaldehyde resin-impregnated wood veneers (or 1 to 2 layers of phenol-formaldehyde resin-impregnated bamboo curtain sheets); or overlaying, from outside toward inside, one hardwood veneer such as Apitong or Keruing, or other wood veneer of similar properties, and 2 to 3 layers of phenol-formaldehyde resin-impregnated wood veneers.

In one embodiment, the invention may comprise a manufacturing process to produce reinforced composite container flooring with resin-impregnated veneers characterized by the following processing steps:
a. Wood veneer treatment: drying the wood veneers to moisture content of less than about 12%. According to the wood species and its location inside the mat, some veneers should be resinated on both sides with a spread rate of 250 to 350 g/m2 (liquid resin with solid content of 40% to 50%); some veneers should be impregnated with resin with the retention rate of 15% to 50% (proportion of the weight of resin solid content and the oven-dry weight of the wood veneer) and then conditioning or drying them under low temperature, preferably lower than the onset temperature of that particular resin. A certain proportion of preservative will be added to the resin;
b. Core layer: using structural strand-based panel or multi-layer wood veneers assembled according to layout requirements of container flooring as the core layer. The structural strand-based panel should be sanded to the target thickness (which is subject to the materials of surface layer) and should be resinated on both sides.
c. Mat assembly: Apply separately or together the resin-impregnated veneers, resin-impregnated paper, and hardwood veneers to assemble them with structural strand-based panel or multi-layer wood veneers to form the mat. Consolidating the mat with hot pressing under conditions of press temperature from 125 to 150° C. and press pressure from 2.0 to 4.0 MPa for 5 to 10 minutes, or longer if the core layer has not previously been consolidated, after the target thickness is reached. Then gradually reduce the press in steps for degassing and relief the press pressure.

In the Figures, which illustrate exemplary embodiments of the invention, (1) is a parallel-grained phenol-formaldehyde resin-impregnated wood veneer that has been dried under low temperature; (2) is a perpendicular-grained phenol-formaldehyde resin-impregnated wood veneer that has been dried under low temperature; (3) is a strand-based core panel; (4) is a multiple-layer veneer core structure assembled in accordance with layout requirements of container flooring; (5) is a wood veneer such as a Keruing or Apitong wood veneer; (6) is a resin-impregnated bamboo curtain sheet (or bamboo woven-mat sheet); and (7) is a phenol-formaldehyde resin-impregnated paper.

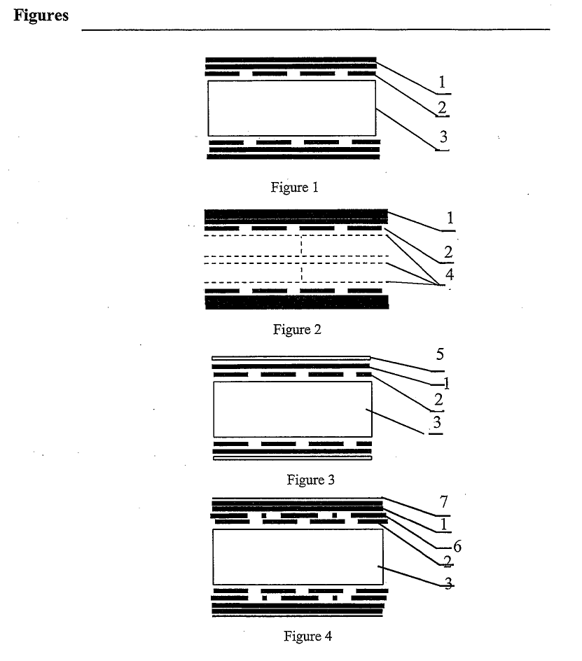

In one embodiment, the invention comprises a wood composite material comprising low density wood species as raw materials. As shown in FIG. 1, the material includes at least two surface layers of parallel-grained resin-impregnated wooden veneer (1), a wood veneer layer of perpendicular-grained resin-impregnated wood veneer (2) and a core layer comprising wood strands (3). Preferably, the perpendicular-grained resin-impregnated veneer layer (2) is adjacent to the to the core layer (3). In one embodiment, the floorboard can be fabricated from veneers of poplar, pine (Larch, Chinese red pine, Simao pien, and etc.), eucalyptus, spruce or fir, and a core board of structural strand-based board (furnished from a single tree species or a mixture of various tree species with similar properties). The structure of this floorboard is to symmetrically lay, in sequence from inside to outside, one layer of phenol-formaldehyde resin-impregnated perpendicular-grained wooden veneer (2) that has been dried under low temperature, and 2 to 3 layers of phenol-formaldehyde resin-impregnated parallel-grained wooden veneers (1), which have been dried under low temperature, onto both surfaces of the structural strand-based core panel (3).

In one aspect, the invention comprises a method of fabricating a composite container floorboard. In one embodiment, the method may comprise:
a. a step of a wood veneer treatment comprising conditioning the wood veneers to a moisture content of 12% or less; impregnating the wood veneers in a pressure vessel by immersing the wooden veneers in a phenol-formaldehyde resin; applying vacuum to the pressure vessel (−80 KPa) for ten minutes followed by impregnating the veneers for 30 minutes under the pressure of 0.60 MPa; drying the treated veneers under low temperature (below the onset temperature of the resin); adding preservative in a proportion of 2.4 grams of preservative to 1 kilogram of resin (solid content of 45%);
b. a step of forming the core board, wherein the structural strand-based board is made into a core board of the structural strand-based board after being configured into a board of constant thickness and preferably being sanded to a thickness of about 20 mm to about 24 mm; and:
c. a step of mat assembly and hot pressing, wherein the mat is assembled by laying on each upper and lower surface of the core layer, in the sequence from inside to outside, one layer of perpendicular-grained phenol-formaldehyde resin-impregnated wood veneer (2) that has been dried under low temperature and 2 to 3 layers of parallel-grained phenol-formaldehyde resin-impregnated wood veneers (1) that have been dried under low temperature to form the surface layers before being hot pressed at a temperature ranging from 125 to 150° C. and press pressure from 2.0 to 4.0 MPa for 5 to 10 minutes, sequentially stepping down the press pressure, degassing, and then relieving press pressure.

After post-pressing processes, the composite container flooring is completed. The mechanical and physical properties of resulting floorboards are:

MOR in parallel direction: ≧95 MPa

MOR in perpendicular direction: ≧35 MPa

MOE in parallel direction: ≧10500 MPa

MOE in perpendicular direction: ≧3500 MPa

Density: 0.75-0.90 g/cm³

In an alternative embodiment, the wood veneer layers and the wooden-strands layer may be pressed without pre-pressing the core layer. This method may reduce the assembly time however, it may increase the overall pressing time.

In another embodiment as shown schematically in FIG. 2, the floorboard comprises parallel-grained resin-impregnated wood veneers (1), a perpendicular-grained resin-impregnated wood veneer (2) and a multiple-layer veneer core structure (4) assembled in accordance with layout requirements of container flooring.

In one embodiment, the floorboard can be fabricated from veneers of eucalyptus, pine (larch, Chinese red pine, Simao pine and etc.), spruce, and poplar. The core layer is composed of 11 to 13 layers (subject to veneer thickness and wood species) of parallel-grained and perpendicular-grained wooden veneers (4), which are assembled in accordance with layout requirements of container flooring. The structure of this floorboard is to symmetrically lay, in sequence from inside to outside, one layer of perpendicular-grained phenol-formaldehyde resin-impregnated wooden veneer (2) that has been dried under low temperature and 2 to 3 layers of parallel-grained phenol-formaldehyde resin-impregnated wooden veneers (1), which have been dried under low temperature to form the surface layers, onto both sides of the multiple-layer veneer core panel.

In another example, the method of fabricating a composite container flooring comprises:
a. a step of a wood veneer treatment comprising conditioning the wood veneers to a moisture content of 12% or less; impregnating the wood veneers as described above with a resin retention rate of 15% to 50% (proportion of the weight of the resin solid content and oven-dry weight of the wood veneer); drying the treated wooden veneers under a low temperature; adding preservative in a proportion of 2.4 grams of preservative to 1 kilogram of resin (solid content is 45%);
b. a step of using a core board comprising 11 to 13 layers of parallel-grained and perpendicular-grained wooden veneers, such as pine, eucalyptus or poplar in accordance the layout requirement of container flooring, conditioning the core layer to a moisture content of 10% or less; applying resin to both sides of the core layer with a spread rage of 250 to 350 g/m² (the solid content of the liquid resin is 40% to 50%);
c. a step of mat assembly and hot pressing, wherein the mat is assembled by laying on each upper and lower surface of the core layer, in sequence from inside to outside, one layer of perpendicular-grained phenol-formaldehyde resin-impregnated wooden veneer (2), such as spruce, that has been dried under low temperature, and 2 to 3 layers of parallel-grained phenol-formaldehyde resin-impregnated wooden veneers (1), such as eucalyptus or pine, which have been dried under low temperature, before being hot pressed at a temperature ranging from 125 to 150° C. and press pressure from 2.4 to 4.0 MPa for 5 to 10 minutes, sequentially stepping down press pressure, degassing, and then relieving press pressure. Or conduct cold water into the hot press platens until panels drops to certain temperature and relief the press pressure.

After post-pressing processes, the composite container flooring is completed. The mechanical and physical properties of resulting floorboards are:

MOR in parallel direction: ≧100 MPa

MOR in perpendicular direction: ≧35 MPa

MOE in parallel direction: ≧11000 MPa

MOE in perpendicular direction: ≧3500 MPa

Density: 0.75-0.90 g/cm³.

In an alternative embodiment, the surface wood veneer layers and core veneer layers may be pressed without pre-pressing the core layer. This method may reduce the assembly time however, it may increase the overall pressing time.

In another embodiment as shown schematically in FIG. 3, the floorboard comprises a Keruing or Apitong wood veneer (5), a parallel-grained resin-impregnated wood veneer (1), a perpendicular-grained resin-impregnated wood veneer (2), and a strand-based core panel (3). In one embodiment, the floorboard can be fabricated from Keruing or Apitong (or other wood veneer of similar properties) veneers and resin-impregnated pine (Larch, Chinese red pine, Simao pine, and etc.), poplar and other veneers as the surface layer, and a structural strand-based panel as a core layer. The structure of this floorboard is to symmetrically lay, in sequence from inside to outside, one layer of phenol-formaldehyde resin-impregnated perpendicular-grained wooden veneer (2) that has been dried under low temperature, one layer of phenol-formaldehyde resin-impregnated parallel-grained wooden veneer (1) that has been dried under low temperature, and one layer of Keruing or Apitong veneer (5), onto both surfaces of the structural strand-based core panel (3).

In another example, the method of fabricating a composite container floorboard comprises:
a. a step of a wood veneer treatment comprising conditioning the Keruing or Apitong veneer (or another wood veneer of similar properties) (5) to a moisture content of 10% or less; conditioning the wood veneers (1) and (2) formed from such woods as pine and poplar respectively, to a moisture content of 13% or less; impregnating wooden veneers (1) and (2) with resin as described above; drying the treated wooden veneers under low temperature; adding preservative in a proportion of 2.4 grams of preservative to 1 kilogram of resin (solid content is 45%);
b. a step of forming the core board, wherein the structural strand-based board is made into a core board of the structural strand-based board after being configured into a board of constant thickness and preferably being sanded to a thickness of about 20 mm to about 24 mm; and:
c. a step of mat assembly and hot pressing wherein the mat is assembled by laying on each upper and lower surface of the core layer, in sequence from inside to outside, one layer of perpendicular-grained phenol-formaldehyde resin-impregnated wooden veneer (2), such as poplar, which has been dried under low temperature, one layer of parallel-grained phenol-formaldehyde resin-impregnated wooden veneer (1), such as pine, which has been dried under low temperature, and one layer of Keruing or Apitong veneer (5) (or other wood veneer of similar properties) as the outmost surface layers before being hot pressed at a temperature ranging from 125 to 150° C. and press pressure of 2.0 to 4.0 MPa for 5 to 10 minutes, sequentially stepping down press pressure, degassing, and then relieving press pressure.

After post-pressing processes, the composite container flooring is completed. The mechanical and physical properties of the resulting floorboard are the same as those described by the embodiment schematically shown in FIG. 2.

In another embodiment as shown in schematically in FIG. 4, the floorboard comprises a piece of resin-impregnated paper (7), a parallel-grained resin-impregnated wood veneer (1), a resin-impregnated bamboo curtain sheet (or bamboo woven-mat sheet) (6), a perpendicular-grained resin-impregnated wood veneer (2) and a strand-based core panel (3).

In one embodiment, the floorboard can be fabricated from resin impregnated paper, resin-impregnated veneers of poplar, eucalyptus, pine (Larch, Chinese red pine, Simao pine, and etc.), and resin-impregnated bamboo curtain sheets (bamboo woven-mat sheet) as the surface layers, and the structural strand-based panel as the core layer. The structure of this floorboard is to symmetrically lay, in sequence from inside to outside, one layer of perpendicular-grained phenol-formaldehyde resin-impregnated wooden veneer (2) that has been that has been dried under low temperature, one layer of resin-impregnated bamboo curtain sheet (or bamboo woven mat) (6), 1 to 2 layers of parallel-grained resin-impregnated wooden veneer (1) which have been dried under low temperature, and one layer of resin impregnated paper (7) onto both surfaces of the structural strand-based core panel (3)

In one example, the method of fabricating a composite container floorboard comprises:
a. a step of a wood veneer and bamboo curtain treatment comprising conditioning the wood veneers to a moisture content of 12% or less; impregnating the wood veneers as described above with a resin retention rate of 15% to 50% (proportion of the weight of the resin solid content and oven-dry weight of the wood veneer); drying the treated wooden veneers under low temperature; dry the bamboo curtain sheets to a moisture content of 12% or less; dilute the phenol-formaldehyde resin to solid content of 30% to 36%; impregnate the bamboo curtain sheets under normal pressure with the resin retention rate of 7% to 10%; adding a preservative to the resin;
b. a step of forming the core board, wherein the structural strand-based board is made into a core board of the structural strand-based board after being configured into a board of constant thickness and preferably being sanded to a thickness of about 20 mm to about 24 mm; and:
c. a step of mat assembly and hot pressing, wherein the mat is assembled by laying on each lower and upper surface of the core layer, in sequence from inside to outside, one layer of perpendicular-grained phenol-formaldehyde resin-impregnated wooden veneer (2), such as poplar, that has been dried under low temperature, one layer of resin-impregnated bamboo curtain sheet (or bamboo woven-mat sheet) (6), 2 layers of parallel-grained phenol-formaldehyde resin-impregnated wooden veneer (1), such as pine or eucalyptus, that has been dried under low temperature and one layer of phenol-formaldehyde resin-impregnated paper before being hot pressed at a temperature ranging from 125 to 150° C. and press pressure from 2.0 to 4.0 MPa for 5 to 10 minutes, sequentially stepping down the press pressure, degassing, and then relieving press pressure.

After post-pressing processes, the composite container flooring is completed. The mechanical and physical properties of the resulting floorboard are the same as those described by the embodiment schematically shown in FIG. 2.

As will be apparent to those skilled in the art, various modifications, adaptations and variations of the forgoing specific disclosure can be made without departing from the scope of the invention claimed herein. The various features and elements of the described invention may be combined in a manner different from the combinations described or claims herein, without departing from the scope of the invention.

What is claimed is:

1. A container flooring comprising a core layer and symmetrical surface layers on both surfaces of the core panel each comprising a resin-impregnated wood veneer layer.

2. The container flooring of claim 1 wherein the resin-impregnated wood veneer layer comprises poplar, pine, eucalyptus, spruce or fir wood.

3. The container flooring of claim 1 wherein the surface layers each comprise, in sequence from inside toward outside, at least one layer of perpendicular-grained phenol-formaldehyde resin-impregnated wooden veneer, and at least 2 layers of parallel-grained resin-impregnated wooden veneers.

4. The container flooring of claim 1 wherein the resin-impregnated wooden veneers have been dried under low temperature.

5. The container flooring of claim 1 wherein the core layer comprises a structural strand-based panel or a multi-layer wood veneer panel.

6. The container flooring of claim 5 wherein the core layer comprises multiple layers of parallel-grained and perpendicular-grained veneers assembled in accordance with layout requirements of container flooring to form the core layer.

7. The container flooring of claim 6 wherein the core layer comprises 11 to 13 layers of parallel-grained and perpendicular-grained veneers.

8. The container flooring of claim 1 wherein each surface layer further comprises an outer hardwood veneer layer.

9. The container flooring of claim 1 wherein each surface layer further comprises an outer layer of resin-impregnated paper as the outermost surface layer.

10. The container flooring of claim 1 wherein each surface layer farther comprises a layer of resin-impregnated bamboo curtain sheet or woven-mat sheet.

11. A method of manufacturing a container flooring comprising a core layer and surface layers on both surfaces of the core panel each comprising a resin-impregnated wood veneer layer, comprising the step of impregnating the wood veneer with a resin, symmetrically assemble the surface layers with the core layer to form a mat; consolidate the assembled mat by hot-pressing; gradually reducing the press pressure in steps for degassing and relieving the press pressure.

12. The method of claim 11 wherein the surface layers further comprises a resin-impregnated paper or a resin-impregnated bamboo layer, comprising the step of impregnating the paper or bamboo layer with a resin.

13. The method of claim 11 comprising the steps of: drying the wood veneer to a moisture content of less than about 12%, spread resin on both sides with the spread rate of 250 to 350 g/m² (resin solid content is 40% to 50%); impregnate the wood veneer with resin with the resin retention rate of 15% to 50% and then are conditioned or dried under low temperature.

14. The method of claim 12 comprising the steps of: drying the bamboo layer to a moisture content of less than about 12%, diluting the resin to a solid content of 30% to 36%, impregnating the bamboo with resin under the normal pressure with the resin retention of 7% to 10%.

15. The method of claim 11 comprising the hot-pressing conditions comprise a press temperature from 125 to 150° C. and press pressure from 2.0 to 4.0 MPa for 5 to 10 minutes.

16. The method of claim 11 wherein the resin impregnation step comprises a direct pressurized treatment; a vacuum and pressurized treatment; a pressurized, vacuum and pressurised treatment; or a combination of repeat vacuum and pressurized treatments to induce the resin to penetrate into cell lumens and cell walls of the veneers.

17. The method of claim 11 wherein the core layer comprises a strand layer and is pre-pressed prior to mat consolidation.
